(19) United States
(12) Patent Application Publication
(10) Pub. No.: US 2026/0302282 A1
(43) Pub. Date: Oct. 1, 2026

(54) END UNIT OF FUEL CELL

(71) Applicant: Honda Motor Co., Ltd., Tokyo (JP)

(72) Inventors: Tomoki Hori, Saitama (JP); Kazuma Hiroe, Saitama (JP)

(21) Appl. No.: 19/574,314

(22) Filed: Mar. 21, 2026

(30) Foreign Application Priority Data
Mar. 26, 2025 (JP) 2025-051095

(51) Int. Cl. H01M 8/04082; H01M 8/0247; H01M 8/0271; H01M 8/10; H01M 8/248

(52) U.S. Cl. CPC H01M 8/04201; H01M 8/0247; H01M 8/0271; H01M 8/248; H01M 2008/1095

(57) ABSTRACT

An end unit of a fuel cell including an insulating member provided with a flow path through-hole communicating with a flow path of a cell stacked body, and an end plate disposed adjacent to the insulating member and provided with an accommodation through-hole accommodating a part of the insulating member. The insulating member includes a first insulating member disposed between the cell stacked body and the end plate, and a second insulating member accommodated in the accommodation through-hole. The end unit of the fuel cell further includes a first seal member having elasticity interposed between the first insulating member and a first end surface of the second insulating member, and a second seal member having elasticity interposed between a second end surface of the second insulating member and a pipe member attached to the end plate so as to communicate with the flow path through-hole.

### CROSS-REFERENCE TO RELATED APPLICATION

This application is based upon and claims the benefit of priority from Japanese Patent Application No. 2025-051095 filed on Mar. 26, 2025, the content of which is incorporated herein by reference.

### BACKGROUND OF THE INVENTION

### Field of the Invention

This invention relates to an end unit of a fuel cell.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack, a structure of an end portion of a fuel cell in which a resin cylindrical member is inserted into a through-hole of an end plate has been known. Such a structure is described in, for example, Japanese Unexamined Patent Publication No. 2023-141081 (JP2023-141081A). In the structure described in JP2023-141081A, the cylindrical member is arranged such that the end surface of the end plate and the end surface of the cylindrical member are substantially coplanar.

However, in the structure described in JP2023-141081A, since variations occur in the dimensions of the cylindrical member that is a resin molded product, the end surface of the end plate and the end surface of the cylindrical member cannot be matched with high accuracy. For this reason, when piping is attached to the outside of the end plate and the piping is connected to the cylindrical member, it is difficult to ensure sufficient sealing between the piping and the cylindrical member.

### SUMMARY OF THE INVENTION

An aspect of the present invention is an end unit of a fuel cell disposed at an end of the fuel cell, the fuel cell including a cell stacked body, the cell stacked body including a plurality of power generation cells stacked in a predetermined direction and a flow path formed in the predetermined direction, the end unit of the fuel cell including an insulating member in which a flow path through-hole is provided so as to communicate with the flow path, and an end plate disposed adjacent to the insulating member, a part of the insulating member being accommodated in an accommodation through-hole provided in the end plate. The insulating member includes a first insulating member disposed between the cell stacked body and the end plate, and a second insulating member accommodated in the accommodation through-hole, a length of the second insulating member in the predetermined direction is equal to or shorter than a length of the end plate in the predetermined direction. The end unit of the fuel cell further includes a first seal member having an elasticity interposed between the first insulating member and a first end surface of the second insulating member, and a second seal member having an elasticity interposed between a second end surface of the second insulating member and a pipe member attached to the end plate so as to communicate with the flow path through-hole.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an overall configuration of a fuel cell stack including an endo unit of a fuel cell according to an embodiment of the present invention;

FIG. 2 is a cross-sectional view taken along line II-II of FIG. 1;

FIG. 3 is a side view illustrating an external shape of a collar included in the end unit of the fuel cell according to the embodiment of the present invention;

FIG. 4A is a cross-sectional view taken along line A-A of FIG. 3;

FIG. 4B is a cross-sectional view taken along line B-B of FIG. 3;

FIG. 5 is a plan view illustrating a state where the collar in FIG. 3 is inserted into the through-hole of the end plate in FIG. 2;

FIG. 6 is a cross-sectional view taken along line VI-VI of FIG. 5;

FIG. 7 is a diagram schematically illustrating a configuration of the end unit of the fuel cell according to the embodiment of the present invention; and

FIG. 8 is a diagram illustrating a reference example of FIG. 7.

### DETAILED DESCRIPTION OF THE INVENTION

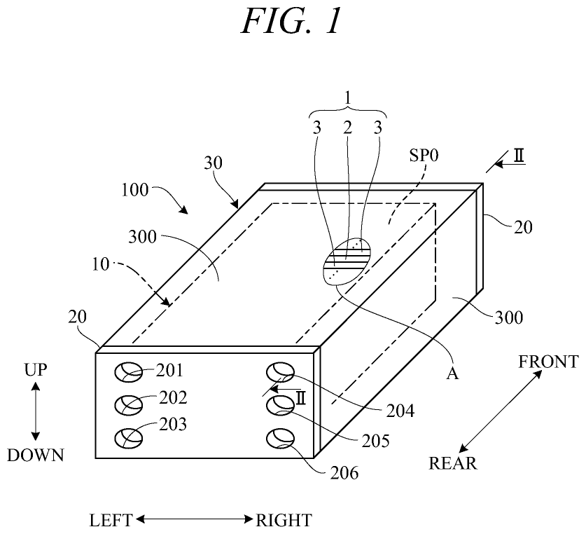

Hereinafter, embodiments of the present invention will be described with reference to FIGS. 1 to 8. An end unit of a fuel cell according to an embodiment of the present invention is configured as part of a fuel cell stack which is one of main components of a fuel cell. The fuel cell can be mounted on a vehicle, for example, and is capable of generating electric power for actuating the vehicle. It is also possible to mount the fuel cell on movable bodies, such as aircraft or ships other than vehicles, robots, and various industrial machines.

First, an overall configuration of a fuel cell stack will be described. FIG. 1 is a perspective view schematically illustrating an overall configuration of a fuel cell stack 100 including an end unit of a fuel cell according to an embodiment of the present invention. Hereinafter, for the sake of convenience, three-axis directions orthogonal to one another as illustrated in the drawings are defined as a front-rear direction, a left-right direction, and an up-down direction, and a configuration of each unit will be described in accordance with such definitions. The front-rear direction in FIG. 1 corresponds to a stacking direction of the fuel cell stack 100. The front-rear direction and the left-right direction in FIG. 1 are not necessarily identical to a front-rear direction and a left-right direction of a vehicle.

As illustrated in FIG. 1, the fuel cell stack 100 includes: a cell stacked body 10; end units 20, which are disposed at both end portions of the cell stacked body 10 in the front-rear direction; and a case 30, which is disposed around the cell stacked body 10 so as to surround the cell stacked body 10. Its entirety has a substantially rectangular parallelepiped shape. A length of the fuel cell stack 100 in the left-right direction is longer than a length of the fuel cell stack 100 in the up-down direction. Therefore, the left-right direction in FIG. 1 is the longitudinal direction, and the up-down direction is the short direction.

The case 30 has four substantially rectangular side walls 300, which respectively face an upper surface, a left surface, a lower surface, and a right surface of the cell stacked body 10. These four side walls 300 define a substantially box-shaped accommodation space SP0 in which the front surface and the rear surface are open. The front surface and the rear surface of the case 30 each are covered with the end unit 20 having a substantially rectangular plate shape.

In a part A in FIG. 1, a part of an upper wall 31 of the case 30 is indicated in a broken state. As indicated by the part “A” in FIG. 1, the cell stacked body 10 has a plurality of power generation cells 1 (for convenience, only a single power generation cell 1 is shown) arranged in the accommodation space SP0.

The power generation cell 1 includes: a unitized electrode assembly (hereinafter, referred to as UEA) 2 having a membrane electrode assembly including an electrolyte membrane and an electrode; and separators 3, which are respectively disposed on both front and rear sides of the UEA 2 to sandwich the UEA 2. The UEA 2 and the separator 3 are alternately disposed in the front-rear direction. The UEA 2 can also be referred to as a membrane electrode structure.

The separator 3 includes a pair of front and rear metal thin plates each having a corrugated cross-section, and outer peripheral portions of the pair of thin plates are bonded to each other to be integrally configured. A cooling flow path through which a cooling medium (for example, water) flows is formed inside the pair of thin plates, and a power generation surface of the power generation cell 1 is cooled by the flow of the cooling medium. The separator 3 on the front side of the UEA 2 is a separator, for example, on an anode side (an anode separator), and an anode flow path through which a fuel gas containing hydrogen flows is formed between the anode separator 3 and the UEA 2. The separator 3 on the rear side of the UEA 2 is a separator, for example, on a cathode side (a cathode separator), and a cathode flow path through which an oxidant gas containing oxygen flows is formed between the cathode separator 3 and the UEA 2.

The UEA 2 includes: a membrane electrode assembly (hereinafter, referred to as MEA); and a thin plate-shaped frame made of resin that supports the periphery of the MEA. The MEA includes an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode includes: an electrode catalyst layer, which is formed on the front surface of the electrolyte membrane, and which serves as a reaction field of an electrode reaction; and a gas diffusion layer, which is provided on the front surface of the electrode catalyst layer, and which diffuses and supplies a fuel gas. The cathode electrode includes: an electrode catalyst layer, which is formed on the rear surface of the electrolyte membrane, and which serves as a reaction field of an electrode reaction; and a gas diffusion layer, which is provided on the rear surface of the electrode catalyst layer, and which diffuses and supplies an oxidant gas.

At the anode electrode, the fuel gas (hydrogen) supplied through the anode flow path and the gas diffusion layer is ionized by the action of the catalyst, passes through the electrolyte membrane, and moves toward the cathode electrode side. Electrons generated at this time pass through an external circuit, and are extracted as electric energy. At the cathode electrode, the oxidant gas (oxygen) supplied through the cathode flow path and the gas diffusion layer reacts with hydrogen ions guided from the anode electrode and electrons moved from the anode electrode, and generates water. The generated water gives an appropriate humidity to the electrolyte membrane, and excessive water is discharged to the outside of the UEA 2.

The front end unit 20 is a dry end unit, and the rear end unit 20 is a wet end unit. In the rear end unit 20, through-holes 201 to 206 penetrating the rear end unit 20 in the front-rear direction are opened. The front end unit 20 is closed. The through-holes 201 to 203 are arranged at the left end portion of the rear end unit 20 with positions shifted in the up-down direction. The through-holes 204 to 206 are arranged at the right end portion of the rear end unit 20 with positions shifted in the up-down direction.

Inside the cell stacked body 10, the fuel gas is supplied through the through-hole 201, the oxidant gas is supplied through the through-hole 204, and the cooling medium is supplied through the through-hole 205. From the cell stacked body 10, the cooling medium is discharged through the through-hole 202, the oxidant exhaust gas is discharged through the through-hole 203, and the fuel exhaust gas is discharged through the through-hole 206. The oxidant exhaust gas is oxidant gas after a part has been used at the cathode electrode, and the fuel exhaust gas is fuel gas after a part has been used at the anode electrode.

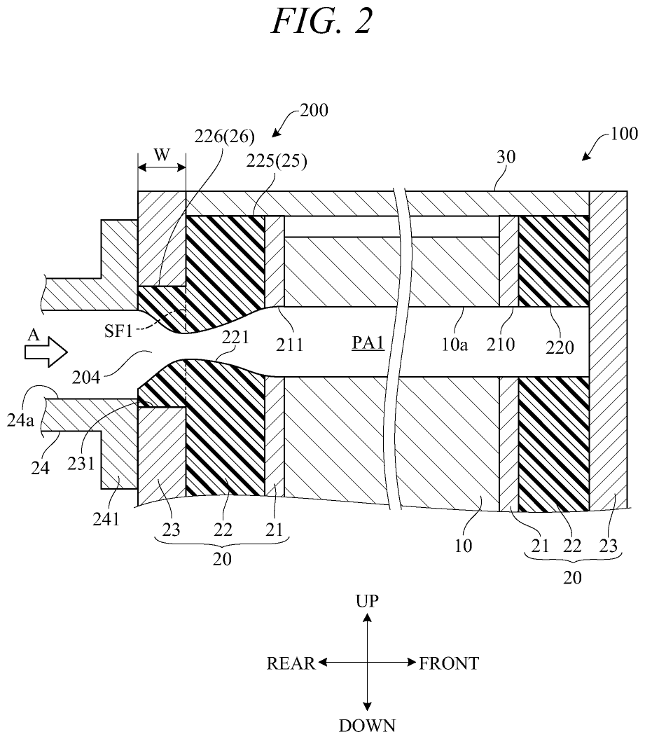

FIG. 2 is a cross-sectional view taken along the through-hole 204 of FIG. 1 (cross-sectional view taken along line II-II of FIG. 1), illustrating a schematic configuration of the end unit 20. In FIG. 2, illustration of the power generation cell 1 is omitted. As illustrated in FIG. 2, the rear end unit 20 includes a terminal plate 21 disposed adjacent to a rear end surface of a cell stacked body 10, an insulating plate 22 disposed adjacent to a rear end surface of the terminal plate 21, and an end plate 23 disposed adjacent to a rear end surface of the insulating plate 22. Similarly, the front end unit 20 includes the terminal plate 21 disposed adjacent to a front end surface of the cell stacked body 10, the insulating plate 22 disposed adjacent to a front end surface of the terminal plate 21, and the end plate 23 disposed adjacent to a front end surface of the insulating plate 22.

The terminal plate 21 is a substantially rectangular plate-shaped member made of metal, and has a terminal portion for extracting electric power generated by an electrochemical reaction in the cell stacked body 10. The insulating plate 22 is a substantially rectangular plate-shaped member made of a non-conductive resin. The insulating plate 22 is formed by resin molding and electrically insulates the terminal plate 21 and the end plate 23 from each other. The end plate 23 is a substantially rectangular plate-shaped member made of metal or a resin configured to have high strength. The terminal plate 21 and the insulating plate 22 are disposed inside a case 30. A pair of front and rear end plates 23 are fastened to a front end surface and a rear end surface of the case 30, respectively, by bolts (not illustrated).

A communication hole 10a extending in a front-rear direction while penetrating a plurality of power generation cells 1 is provided inside the cell stacked body 10. The communication hole 10a, together with the through-hole 204, forms a flow path through which a reactant gas (oxidant gas) flows, that is, a flow path PA1 for supplying the oxidant gas.

In the front-side terminal plate 21, a through-hole 210 penetrating the terminal plate 21 in the front-rear direction is opened. In the front-side insulating plate 22, a through-hole 220 penetrating the insulating plate 22 in the front-rear direction is opened. The through-holes 210 and 220 communicate with the communication hole 10a and constitute a part of the flow path PA1. In the front-side end plate 23, no through-hole communicating with the communication hole 10a is formed.

In the rear-side terminal plate 21, a through-hole 211 penetrating the terminal plate 21 in the front-rear direction is opened. In the rear-side insulating plate 22, a through-hole 221 penetrating the insulating plate 22 in the front-rear direction is opened. In the rear-side end plate 23, a through-hole 231 penetrating the end plate 23 in the front-rear direction is opened. The through-holes 211 and 221 communicate with the communication hole 10a and constitute a part of the flow path PA1. The through-holes 211 and 221 correspond to the through-hole 204 of FIG. 1.

Although not illustrated, other through-holes 301 to 303, 305, and 306 similarly form flow paths together with the communication hole 10a. That is, the through-hole 301 forms a flow path for supplying fuel gas together with the communication hole 10a, the through-hole 302 forms a flow path for discharging a cooling medium together with the communication hole 10a, the through-hole 303 forms a flow path for discharging oxidant gas together with the communication hole 10a, the through-hole 305 forms a flow path for supplying a cooling medium together with the communication hole 10a, and the through-hole 306 forms a flow path for discharging fuel gas together with the communication hole 10a.

On the rear-side end plate 23, a flange portion 241 of a pipe member 24 is attached via bolts. A reactant gas (oxidant gas) is supplied to the flow path PA1 of a fuel cell stack 100 through a flow path 24a inside the pipe member 24, as indicated by arrow A.

The rear-side insulating plate 22 includes a plate body portion 225 disposed between the terminal plate 21 and the end plate 23, and a protruding portion 226 protruding rearward from the plate body portion 225. A plane along the front end surface of the end plate 23 is a boundary surface SF1 between the plate body portion 225 and the protruding portion 226. The protruding portion 226 is inserted into the through-hole 231 of the end plate 23.

A cross-sectional shape of the flow path 24a of the pipe member 24 is substantially circular. At a rear end of the protruding portion 226, the through-hole 221 has a substantially circular shape identical to the cross-sectional shape of the pipe member 24. However, a cross-sectional shape of the flow path PA1 is not constant within a range of a thickness W from the front end surface (the boundary surface SF1) to the rear end surface of the end plate 23. That is, the cross-sectional shape of the flow path PA1 gradually changes in the front-rear direction, and becomes substantially circular at the rear end of the flow path PA1.

In the present embodiment, within the range of the thickness W of the end plate 23, the flow path PA1 is formed by the protruding portion 226 of the insulating plate 22 rather than by the end plate 23. Accordingly, the flow path PA1 having a complex shape can be easily formed. In addition, since the end plate 23 is not in contact with a reactant gas or a cooling medium, corrosion of the end plate 23 can be prevented.

Meanwhile, when the plate body portion 225 and the protruding portion 226 are integrally molded, the insulating plate 22 becomes large in size, which may cause molding defects such as sink marks or voids. Therefore, in the present embodiment, the insulating plate 22 is divided into front and rear portions along the boundary surface SF1, and a portion (referred to as a plate body 25) corresponding to the plate body portion 225 and a portion (referred to as a collar 26) corresponding to the protruding portion 226 are molded separately.

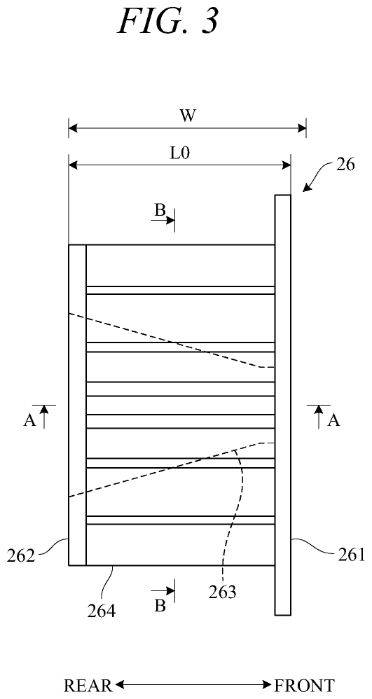

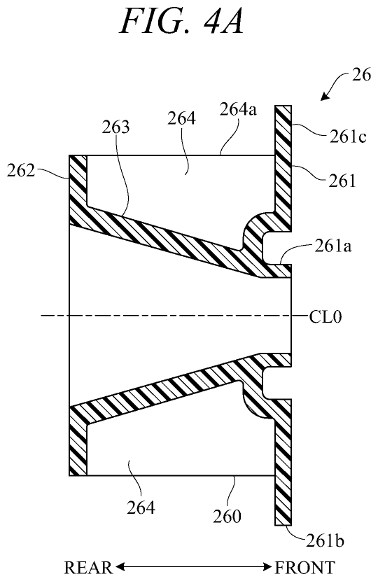

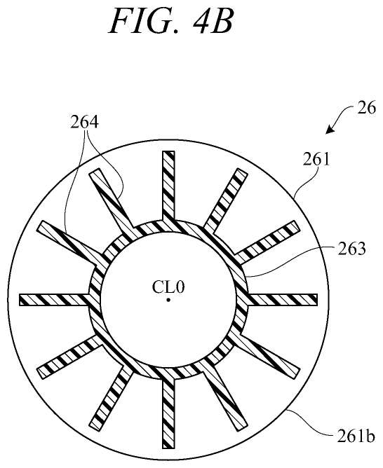

FIG. 3 is a side view of the collar 26 alone (for example, a view seen from the right side), illustrating an external shape of the collar 26. FIG. 4A is a cross-sectional view taken along line A-A of FIG. 3, and FIG. 4B is a cross-sectional view taken along line B-B of FIG. 3. In the following description, the configuration of the collar 26 will be described on the assumption, for convenience, that the collar 26 has a symmetrical shape about a center line CL0 (FIG. 4A) extending in the front-rear direction.

As illustrated in FIGS. 3, 4A, and 4B, the collar 26 includes a front plate portion 261 and a rear plate portion 262 that are spaced apart from each other in the front-rear direction and extend in the up-down and left-right directions, a cylindrical portion 263 connecting the front plate portion 261 and the rear plate portion 262, and a plurality of rib portions 264 extending radially outward from an outer peripheral surface of the cylindrical portion 263.

The front plate portion 261 and the rear plate portion 262 each have a substantially ring shape centered on the center line CL0. An outer diameter of the front plate portion 261 is larger than an outer diameter of the rear plate portion 262, and an inner diameter of the front plate portion 261 is smaller than an inner diameter of the rear plate portion 262. As illustrated in FIG. 4A, a substantially ring-shaped recess 261a extending over an entire circumference about the center line CL0 is provided on the front end surface of the front plate portion 261. The rear end surface of the rear plate portion 262 is formed flat.

The cylindrical portion 263 extends in the front-rear direction from an inner edge of the front plate portion 261 to an inner edge of the rear plate portion 262, and forms a part (through-hole 221) of the flow path PA1 (FIG. 2). The cylindrical portion 263 is formed in a tapered shape such that a flow-path area gradually increases toward the rear. As illustrated in FIG. 4B, the rib portions 264 are provided radially about the center line CL0. As illustrated in FIG. 4A, each rib portion 264 is a plate member having a substantially rectangular shape, more specifically, a substantially trapezoidal shape, and three sides of the rib portion 264, except for a radially outward end surface 264a, are connected to the front plate portion 261, the cylindrical portion 263, and the rear plate portion 262, respectively. The radially outward end surface 264a of the rib portion 264 extends in the front-rear direction substantially parallel to the center line CL0, and the end surface 264a is positioned on a cylindrical surface 260 obtained by extending an outer peripheral surface of the rear plate portion 262 forward. The front plate portion 261 has a protruding portion 261c of which an outer peripheral surface 261b protrudes radially outward beyond the cylindrical surface 260.

As described above, the collar 26 includes a plurality of plate portions (the front plate portion 261, the rear plate portion 262, the cylindrical portion 263, and the rib portions 264). Plate thicknesses of these plate portions are constant or substantially constant, and variations in the plate thickness are small. Accordingly, occurrence of molding defects such as sink marks in the collar 26 can be prevented.

As illustrated in FIG. 3, when a length from the front end surface to the rear end surface of the collar 26 is defined as L0, the length L0 is smaller than the thickness W of the end plate 23 of FIG. 2. More specifically, in a case where manufacturing tolerances of the end plate 23 and the collar 26 are taken into account, the maximum-dimension length L0 of the collar 26 is smaller than the minimum-dimension length (the thickness W) of the end plate 23. The maximum-dimension length L0 of the collar 26 may be equal to the minimum-dimension length (the thickness W) of the end plate 23. That is, the length L0 of the collar 26 may be equal to or less than the thickness W of the end plate 23.

In FIG. 4B, the outer peripheral surface 261b of the front plate portion 261 of the collar 26 is configured to have a substantially circular shape centered on the center line CL0; however, the outer peripheral surface 261b is not limited to a circular shape. For example, the outer peripheral surface 261b may be configured to be non-uniform in the circumferential direction, such as by cutting off a part of the front plate portion 261 located radially outward of the cylindrical surface 260. The collars 26 are prepared in a number (six) corresponding to the number of the through-holes 231 of the end plate 23 (FIG. 2), and are inserted into the respective through-holes 231. In this case, the collars 26 may be molded such that the front plate portions 261 of a pair of collars 26 are integrally formed in a case where a distance between the outer peripheral surfaces 261b of the front plate portions 261 of the pair of collars 26 arranged adjacent to each other in the up-down direction is equal to or less than a predetermined distance. In other words, parts of the plurality of collars 26 may be integrally molded. Accordingly, the number of assembly steps for assembling the collars 26 can be reduced.

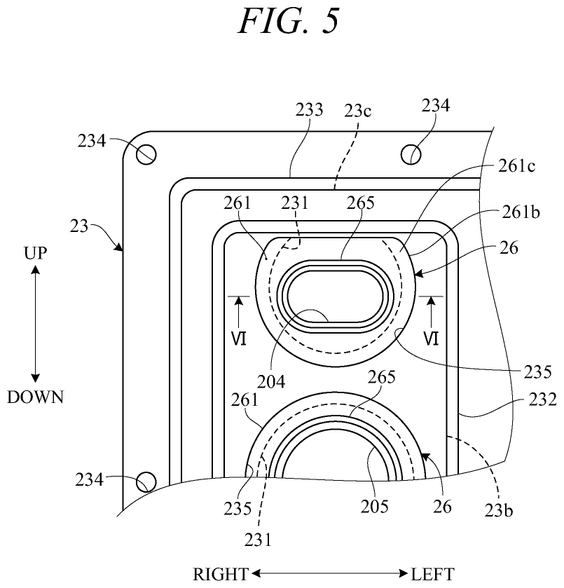

The collar 26 is inserted into the through-hole 231 of the end plate 23 from above during assembly of the fuel cell stack 100, in a state where the rear-side end plate 23 is placed on an assembly table and the front surface of the end plate 23 of FIG. 1 faces upward. FIG. 5 is a plan view (view seen from the front) illustrating a main configuration of the end plate 23 in a state in which the collar 26 is inserted into the through-hole 231. More specifically, FIG. 5 is a plan view in the vicinity of an upper right corner portion of the end plate 23.

As illustrated in FIG. 5, a substantially ring-shaped seal member 265 is accommodated in the recess 261a (FIG. 4A) of the front plate portion 261 of the collar 26. The seal member 265 is a packing having elasticity and having a substantially circular or elliptical cross-sectional shape, and is made of a rubber material or a resin material.

On the right-side front surface of the end plate 23, a substantially rectangular recess 23b is provided to surround three right-side through-holes 204 to 206 (FIG. 1), and a seal member 232 is accommodated in the recess 23b. Inside the seal member 232, three collars 26 (only a part illustrated) respectively accommodated in the through-holes 204 to 206 are disposed. Although not illustrated, similarly, on the left-side front surface of the end plate 23, a substantially rectangular recess is provided to surround three left-side through-holes 201 to 203, the seal member 232 is accommodated in the recess, and three collars 26 respectively accommodated in the through-holes 201 to 203 are disposed inside the seal member 232.

On the front surface of the end plate 23, a substantially rectangular recess 23c is provided along an outer edge of the end plate 23, and a seal member 233 is accommodated in the recess 23c. Outside the seal member 233, a plurality of through-holes 234 penetrating the end plate 23 are opened along the outer edge of the end plate 23. Bolts are inserted into the through-holes 234, and the end plate 23 is fastened to the case 30 (FIG. 2).

The outer peripheral surface 261b of the front plate portion 261 of the collar 26 disposed at the upper right corner portion is not circular, and the front plate portion 261 is formed to have a substantially D shape in plan view by cutting off a part (upper end portion) of the protruding portion 261c. Accordingly, the collar 26 can be easily accommodated in the through-hole 231 without causing the protruding portion 261c to interfere with the seal member 232 located above the protruding portion 261c.

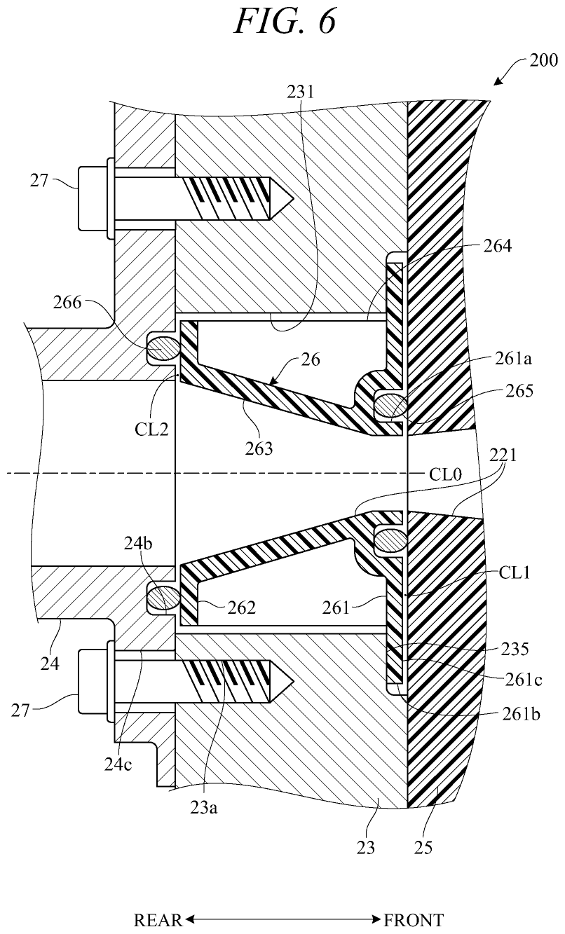

FIG. 6 is a cross-sectional view taken along line VI-VI of FIG. 5. In FIG. 6, the plate body 25 on the front side of the end plate 23 and the pipe member 24 on the rear side thereof are shown together. Accordingly, FIG. 6 is a cross-sectional view illustrating a schematic configuration of an end unit 200 of a fuel cell according to the present embodiment.

As illustrated in FIG. 6, a recess 235 having a predetermined depth is provided on the front end surface of the end plate 23 so as to correspond to the shape of the outer peripheral surface 261b of the front plate portion 261 of the collar 26. The protruding portion 261c of the front plate portion 261 of the collar 26 is accommodated in the recess 235. Accordingly, the position of the collar 26, which is configured to be non-uniform in the circumferential direction, in the circumferential direction can be defined. The recess 235 is formed to be deeper than a plate thickness of the front plate portion 261. Therefore, when the front plate portion 261 is brought into contact with the bottom surface of the recess 235, a gap CL1 is formed between the front end surface of the front plate portion 261 and the rear end surface of the plate body 25.

A substantially ring-shaped recess 24b centered on the center line CL0 is provided on the front end surface of the pipe member 24, at a portion facing the rear plate portion 262 of the collar 26, and a substantially ring-shaped seal member 266 is accommodated in the recess 24b. The seal member 266 is a packing having elasticity and having a substantially circular or elliptical cross-sectional shape, and is made of the same material as the seal member 265. A bottomed screw hole 23a is provided in the rear end surface of the end plate 23. In the pipe member 24, a through-hole 24c corresponding to the screw hole 23a is opened radially outward of the seal member 266. A bolt 27 inserted through the through-hole 24c is screwed into the screw hole 23a, and thus the pipe member 24 is fastened to the end plate 23.

As described above, the length L0 of the collar 26 is shorter than the thickness W of the end plate 23 (FIG. 3). Therefore, in a state in which the pipe member 24 is attached to the end plate 23, a gap CL2 is formed between the front end surface of the pipe member 24 and the rear end surface of the collar 26.

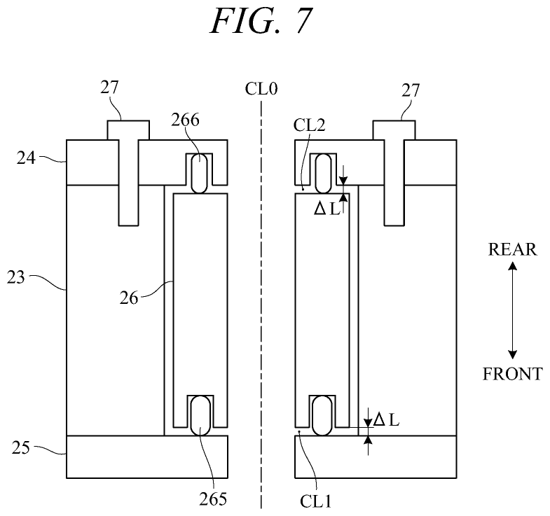

Major operations of the end unit 200 of the fuel cell according to the present embodiment will be described below. FIG. 7 is a diagram schematically illustrating a configuration of the end unit 200 according to the present embodiment. As illustrated in FIG. 7, in a state in which the pipe member 24 is attached to the rear end surface of the end plate 23 by using the bolts 27, the collar 26 is supported between the plate body 25 and the pipe member 24 via the seal members 265 and 266. At this time, the gap CL1 is present between the front end surface of the collar 26 and the plate body 25, and the gap CL2 is present between the rear end surface of the collar 26 and the pipe member 24.

Accordingly, the collar 26 is elastically supported via the seal members 265 and 266 in a state in which both front and rear end surfaces thereof are sealed by the seal members 265 and 266. Since the seal members 265 and 266 are formed of the same member, elastic forces of the seal members 265 and 266 are equal to each other. Therefore, a rearward pressing force acting on the collar 26 by the seal member 265 and a forward pressing force acting on the collar 26 by the seal member 266 are equal to each other, and sizes ΔL of the gaps CL1 and CL2 are equal to each other. The seal members 265 and 266 exhibit desired sealing performance when an amount of compression is within a predetermined range ΔR (for example, 10 to 30%).

In the present embodiment, in consideration of dimensional tolerances of the end plate 23 and the collar 26, thicknesses and the like of the seal members 265 and 266 are set such that, when the gap ΔL is at a minimum and at a maximum, the amount of compression of the seal members 265 and 266 falls within the predetermined range ΔR. Accordingly, favorable sealing performance by the seal members 265 and 266 can be exhibited regardless of the dimensional tolerances of the end plate 23 and the collar 26.

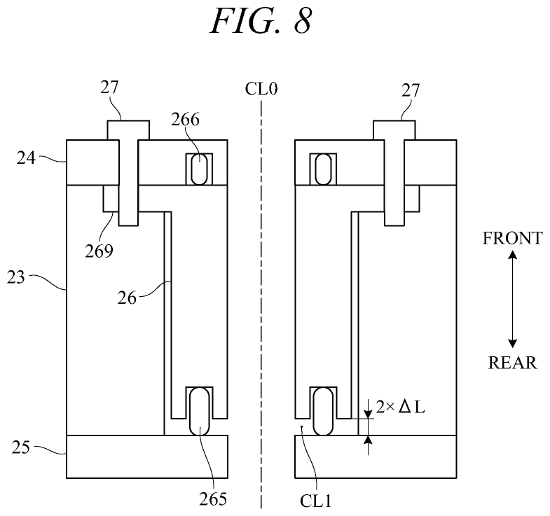

FIG. 8 is a diagram illustrating a reference example of FIG. 7. In FIG. 8, a protruding portion 269 protruding radially outward is provided at the front end portion of the collar 26, and the protruding portion 269 is sandwiched between the end plate 23 and the pipe member 24. Accordingly, no gap CL2 is present between the collar 26 and the pipe member 24, and the gap CL1 is formed only between the collar 26 and the plate body 25. In this case, the size of the gap CL1 becomes twice (2ΔL) the size ΔL of the gaps CL1 and CL2 of FIG. 7. Therefore, it is difficult for a single seal member 265 to absorb the doubled gap CL1, and there is a risk that sufficient sealing performance by the seal member 265 cannot be exhibited.

A method for assembling the fuel cell stack 100 including the end unit 200 of the present embodiment will be described. When assembling the fuel cell stack 100, first, the rear-side end plate 23 is placed on the assembly table with the front surface thereof facing upward. Next, the case 30 is attached to the upper surface of the end plate 23. Next, the collar 26 is accommodated in the through-hole 231 of the end plate 23 placed on the assembly table. At this time, the protruding portion 261c of the front plate portion 261 of the collar 26 is accommodated in the recess 235 of the end plate 23. Accordingly, the collar 26 can be held while being positioned in the circumferential direction, and attachment of the collar 26 is facilitated. Although not shown, the front plate portions 261 of the pair of collars 26 (FIG. 5) arranged adjacent to each other in the up-down direction may be integrally formed, and in such a case, attachment of the collars 26 is further facilitated.

Next, the plate body 25 is placed on the upper surface of the collar 26 via the seal member 265, and the terminal plate 21 is further placed on the upper surface of the plate body 25. Next, a predetermined number of power generation cells 1 are stacked while being positioned by positioning portions (not illustrated). Next, the terminal plate 21, the insulating plate 22, and the end plate 23 that are disposed on the front side are sequentially mounted. In this state, a pressurizing force is applied from above the end plate 23 by using a pressing device to apply a pressing force to the plurality of power generation cells 1, thereby bringing the end plate 23 into contact with the end surface of the case 30 and fastening the end plate 23 to the case 30. Thus, assembly of the fuel cell stack 100 is completed.

After assembly of the fuel cell stack 100 is completed, the fuel cell stack 100 is inverted in the up-down direction so that a rear surface of the rear-side end plate 23 faces upward. In this state, the pipe member 24 is attached to the rear surface of the end plate 23 via the seal member 266 by using the bolts 27.

According to the present embodiment, the following operations and effects can be achieved.
(1) The end unit 200 of the fuel cell is disposed at an end portion of the fuel cell stack 100 (fuel cell) that includes the cell stacked body 10 in which a plurality of power generation cells 1 are stacked in the front-rear direction (predetermined direction) and in which the flow path PA1 is formed in the front-rear direction (FIGS. 2 and 6). The end unit 200 includes the insulating plate 22 provided with the through-hole 221 communicating with the flow path PA1, and the end plate 23 disposed adjacent to the insulating plate 22 and provided with the through-hole 231 accommodating a part of the insulating plate 22 (FIG. 2). The insulating plate 22 includes the plate body 25 disposed between the cell stacked body 10 and the end plate 23, and the collar 26 accommodated in the through-hole 231 (FIGS. 2 and 6). The length L0 of the collar 26 in the front-rear direction is shorter than the thickness W (length in the front-rear direction) of the end plate 23 (FIG. 3). The end unit 200 further includes the seal member 265 having elasticity interposed between the plate body 25 and a front end surface of the collar 26, and the seal member 266 having elasticity interposed between the rear end surface of the collar 26 and the pipe member 24 attached to the end plate 23 so as to communicate with the through-hole 221 (FIGS. 2 and 6).

With this configuration, the collar 26 is supported between the plate body 25 and the pipe member 24 via the seal members 265 and 266, with the gaps CL1 and CL2 provided between the front end surface of the collar 26 and the plate body 25 and between the rear end surface of the collar 26 and the pipe member 24. The seal members 265 and 266 can exhibit sealing performance as long as an amount of compression in the front-rear direction is within a predetermined range. Therefore, by supporting the collar 26 via the seal members 265 and 266 in a state separated from the plate body 25 and the pipe member 24, dimensional tolerances of the end plate 23 and the collar 26 can be absorbed by variations in compression of the seal members 265 and 266, and favorable sealing performance by the seal members 265 and 266 can be exhibited.
(2) The pipe member 24 is fastened to the end plate 23 by the bolts 27 as fastening portions (FIG. 6). An outer edge of the rear end surface of the collar 26 is positioned inside the through-hole 231 so as not to interfere with the bolts 27 (FIG. 6). Accordingly, the collar 26 can be favorably elastically supported via the seal members 265 and 266.
(3) The end plate 23 has the recess 235 on the front surface thereof facing the plate body 25 (FIG. 6). The collar 26 has the protruding portion 261c that protrudes radially outward beyond a peripheral surface of the through-hole 231 and is accommodated in the recess 235 (FIGS. 4A and 6). Accordingly, when the collar 26 is inserted into the through-hole 231 of the end plate 23 from above, the collar 26 is retained by the end plate 23 via the protruding portion 261c, thereby facilitating assembly of the collar 26.
(4) The protruding portion 261c is configured to have a non-uniform shape in the circumferential direction (FIG. 5). Accordingly, when assembling the collar 26, the position of the collar 26 in the circumferential direction can be easily restricted to a predetermined position.
(5) The collar 26 includes the front plate portion 261, the rear plate portion 262, the cylindrical portion 263 extending from the front plate portion 261 to the rear plate portion 262 and forming the through-hole 204 on an inner peripheral surface thereof, and the rib portions 264 connected to the front plate portion 261, the rear plate portion 262, and the outer peripheral surface of the cylindrical portion 263 (FIGS. 3, 4A, and 4B). By configuring the collar 26 with the plurality of plate portions in this manner, occurrence of molding defects during molding of the collar 26 can be prevented.

The above embodiment can be modified to various forms. Hereinafter, several modified examples will be described. In the above embodiment, the through-hole 221 (a flow path through-hole) communicating with the flow path PA1 is provided in the insulating plate 22 as an insulating member, but the configuration of the flow path through-hole is not limited to that shown in FIG. 2. In the above embodiment, the end plate 23 in which the through hole 231 (an accommodation through-hole) for accommodating a part of the insulating plate 22 is opened is arranged adjacent to the insulating plate 22, but the configuration of the accommodation through-hole is not limited to that shown in FIG. 2. In the above embodiment, the insulating plate 22 is configured by the plate body 25 (a first insulating member) and the collar 26 (a second insulating member) that are resin molded products, but either one or both of the first insulating member and the second insulating member may be configured by a molded product having insulating properties such as rubber material instead of resin material.

In the above embodiment, the length L0 in the front-rear direction of the collar 26 is less than the length (thickness W) in the front-rear direction of the end plate 23, but the length L0 and the thickness W may be equal, and therefore the length L0 may be equal to or less than the thickness W. In the above embodiment, the seal member 265 (a first seal member) is arranged between the plate body 25 and the front end surface (a first end surface) of the collar 26, and the seal member 266 (a second seal member) is arranged between the rear end surface (a second end surface) of the collar 26 and the pipe member 24, but the configuration (cross-sectional shape, etc.) of the first seal member and the second seal member is not limited to those described above. In the above embodiment, the pipe member 24 is fastened to the end plate 23 with the bolt 27, but the configuration of a fastening portion is not limited to that described above. In the above embodiment, the outer edge of the rear end surface of the collar 26 is positioned inside the through-hole 231 of the end plate 23, but if the outer edge of the rear end surface of the collar 26 does not interfere with the bolt 27, the outer edge of the rear end surface of the collar 26 does not need to be inside the through-hole 231.

In the above embodiment, the recess 235 is provided on the front end surface (a facing surface) of the end plate 23 facing the protruding portion 261c of the collar 26, and the protruding portion 261c is accommodated in the recess 235, but the configuration of a protruding portion protruding radially outward from the through-hole 231 is not limited to that described above. In the above embodiment, the collar 26 is configured by the front plate portion 261 (a first plate portion) including the front end surface as a first end surface, the rear plate portion 262 (a second plate portion) including the rear end surface as a second end surface, the cylindrical portion 263 (a flow path forming portion) extending from the front plate portion 261 to the rear plate portion 262 and forming the through-hole 221 for the flow path on the inner peripheral surface, and the rib portion 264 (rib plate portion) connected to the front plate portion 261, the rear plate portion 262, and the cylindrical portion 263, but the configuration of the collar 26 as the second insulating member is not limited to that described above.

The above embodiment can be combined as desired with one or more of the above modifications. The modifications can also be combined with one another.

According to the present invention, an end unit of a fuel cell with good sealing performance can be configured.

Above, while the present invention has been described with reference to the preferred embodiments thereof, it will be understood, by those skilled in the art, that various changes and modifications may be made thereto without departing from the scope of the appended claims.

What is claimed is:

1. An end unit of a fuel cell disposed at an end of the fuel cell, the fuel cell including a cell stacked body, the cell stacked body including a plurality of power generation cells stacked in a predetermined direction and a flow path formed in the predetermined direction, the end unit of the fuel cell comprising:
an insulating member in which a flow path through-hole is provided so as to communicate with the flow path; and
an end plate disposed adjacent to the insulating member, a part of the insulating member being accommodated in an accommodation through-hole provided in the end plate, wherein
the insulating member includes a first insulating member disposed between the cell stacked body and the end plate, and a second insulating member accommodated in the accommodation through-hole,
a length of the second insulating member in the predetermined direction is equal to or shorter than a length of the end plate in the predetermined direction, and
the end unit of the fuel cell further comprises:
a first seal member having an elasticity interposed between the first insulating member and a first end surface of the second insulating member; and
a second seal member having an elasticity interposed between a second end surface of the second insulating member and a pipe member attached to the end plate so as to communicate with the flow path through-hole.

2. The end unit of the fuel cell according to claim 1, wherein
the end plate has a fastening portion to which the pipe member is fastened, and
an outer edge of the second end surface of the second insulating member is located inside the accommodation through-hole so as not to interfere with the fastening portion.

3. The end unit of the fuel cell according to claim 1, wherein
the end plate has a facing surface facing the first insulating member, and a recess provided on the facing surface, and
the second insulating member has a protruding portion protruding radially outward from a peripheral surface of the accommodation through-hole so as to be accommodated in the recess.

4. The end unit of the fuel cell according to claim 3, wherein
the protruding portion is configured in a non-uniform shape in a circumferential direction.

5. The end unit of the fuel cell according to claim 3, wherein
a thickness of the protruding portion in the predetermined direction is smaller than a depth of the recess.

6. The end unit of the fuel cell according to claim 1, wherein
the second insulating member includes:
a first plate portion including the first end surface;
a second plate portion including the second end surface;
a cylindrical flow path forming portion extending from the first plate portion to the second plate portion and forming the flow path through-hole on an inner peripheral surface thereof; and
a rib plate portion connected to the first plate portion, the second plate portion, and an outer peripheral surface of the flow path forming portion.

7. The end unit of the fuel cell according to claim 6, wherein
an inner diameter of the first plate portion is smaller than an inner diameter of the second plate portion.
